(19) United States
(12) Patent Application Publication
(10) Pub. No.: US 2006/0133472 A1
(43) Pub. Date: Jun. 22, 2006

(54) Spatial scalable compression

(75) Inventors: Wilhelmus Hendrikus Alfonsus Bruls, Eindhoven (NL); Gerardus Johannes Maria Vervoort, Eindhoven (NL); Reinier Bernardus Maria Klein Gunnewiek, Eindhoven (NL); Marc Joseph Rita Op De Beeck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/518,834

(22) PCT Filed: Jun. 26, 2003
(86) PCT No.: PCT/IB03/02477

§ 371 Date: Dec. 21, 2004

(30) Foreign Application Priority Data
Jun. 28, 2002 (EP) 02077568.0
Dec. 20, 2002 (EP) 02080635.2

(51) Int. Cl. H04B 1/66; H04N 7/12; H04N 11/02; H04N 11/04

(52) U.S. Cl. 375/240.1; 375/240.08; 375/240.21

(57) ABSTRACT

A method and apparatus for providing spatial scalable compression of a video stream is disclosed. The video stream is downsampled to reduce the resolution of the video stream. The downsampled video stream is encoded to produce a base stream. The base stream is decoded and upconverted to produce a reconstructed video stream. The reconstructed video stream is subtracted from the video stream to produce a residual stream. It is then determined which segments or pixels in each frame have a predetermined chance of having a predetermined characteristic. A gain value for the content of each segment or pixel is calculated, wherein the gain for pixels which have the predetermined chance of having the predetermined characteristic is biased toward 1 and the gain for other pixels is biased toward 0. The residual stream is multiplied by the gain values so as to remove bits from the residual stream which do not correspond to the predetermined characteristic. The resulting residual stream is encoded and outputted as an enhancement stream.

### FIELD OF THE INVENTION

The invention relates to a video encoder/decoder.

### BACKGROUND OF THE INVENTION

Because of the massive amounts of data inherent in digital video, the transmission of full-motion, high-definition digital video signals is a significant problem in the development of high-definition television. More particularly, each digital image frame is a still image formed from an array of pixels according to the display resolution of a particular system. As a result, the amounts of raw digital information included in high-resolution video sequences are massive. In order to reduce the amount of data that must be sent, compression schemes are used to compress the data. Various video compression standards or processes have been established, including, MPEG-2, MPEG-4, and H.263.

Many applications are enabled where video is available at various resolutions and/or qualities in one stream. Methods to accomplish this are loosely referred to as scalability techniques. There are three axes on which one can deploy scalability. The first is scalability on the time axis, often referred to as temporal scalability. Secondly, there is scalability on the quality axis (quantization), often referred to as signal-to-noise (SNR) scalability or fine-grain scalability. The third axis is the resolution axis (number of pixels in image) often referred to as spatial scalability. In layered coding, the bitstream is divided into two or more bitstreams, or layers. Each layer can be combined to form a single high quality signal. For example, the base layer may provide a lower quality video signal, while the enhancement layer provides additional information that can enhance the base layer image.

In particular, spatial scalability can provide compatibility between different video standards or decoder capabilities. With spatial scalability, the base layer video may have a lower resolution than the input video sequence, in which case the enhancement layer carries information which can restore the resolution of the base layer to the input sequence level.

FIG. 1 illustrates a known spatial scalable video encoder 100. The depicted encoding system 100 accomplishes layer compression, whereby a portion of the channel is used for providing a low resolution base layer and the remaining portion is used for transmitting edge enhancement information, whereby the two signals may be recombined to bring the system up to high-resolution. The high resolution video input Hi-Res is split by splitter 102 whereby the data is sent to a low pass filter 104 and a subtraction circuit 106. The low pass filter 104 reduces the resolution of the video data, which is then fed to a base encoder 108. In general, low pass filters and encoders are well known in the art and are not described in detail herein for purposes of simplicity. The encoder 108 produces a lower resolution base stream which can be broadcast, received and via a decoder, displayed as is, although the base stream does not provide a resolution which would be considered as high-definition.

The output of the encoder 108 is also fed to a decoder 112 within the system 100. From there, the decoded signal is fed into an interpolate and upsample circuit 114. In general, the interpolate and upsample circuit 114 reconstructs the filtered out resolution from the decoded video stream and provides a video data stream having the same resolution as the high-resolution input. However, because of the filtering and the losses resulting from the encoding and decoding, loss of information is present in the reconstructed stream. The loss is determined in the subtraction circuit 106 by subtracting the reconstructed high-resolution stream from the original, unmodified high-resolution stream. The output of the subtraction circuit 106 is fed to an enhancement encoder 116 which outputs a reasonable quality enhancement stream.

Although these layered compression schemes can be made to work quite well, these schemes still have a problem in that the enhancement layer needs a high bitrate. One method for improving the efficiency of the enhancement layer is disclosed in PCT application IB02/04297, filed October 2002, entitled “Spatial Scalable Compression Scheme Using Adaptive Content Filtering”. Briefly, a picture analyzer driven by a pixel based detail metric controls the multiplier gain in front of the enhancement encoder. For areas of little detail, the gain (1-α) is biased toward zero and these areas are not encoded as a residual stream. For areas of greater detail, the gain is biased toward 1 and these areas are encoded as the residual stream.

Experiments have shown that the human eye is attracted to other humans and thus the human eye tracks people and especially their faces. It therefore follows that these areas should be encoded as well as possible. Unfortunately, the detail metric is not normally very interested in the subtle details of faces, so normally the alpha value will be relatively high and the faces will mostly be encoded in the lower resolution of the base stream. There is thus a need for a method and apparatus for determining which sections of the total image need to be encoded in the enhancement layer based on human viewing behavior.

### SUMMARY OF THE INVENTION

The invention overcomes at least part of the deficiencies of other known layered compression schemes by using object segmentation to emphasize certain sections of the image in the residual stream while deemphasizing other sections of the image, preferably based on human viewing behavior.

According to one embodiment of the invention, a method and apparatus for providing spatial scalable compression of a video stream is disclosed. The video stream is downsampled to reduce the resolution of the video stream. The downsampled video stream is encoded to produce a base stream. The base stream is decoded and upconverted to produce a reconstructed video stream. The reconstructed video stream is subtracted from the video stream to produce a residual stream. It is then determined which segments or pixels in each frame have a predetermined chance of having a predetermined characteristic. A gain value for the content of each segment or pixel is calculated, wherein the gain for pixels which have the predetermined chance of having the predetermined characteristic is biased toward 1 and the gain for other pixels is biased toward 0. The residual stream is multiplied by the gain values so as to remove bits from the residual stream which do not correspond to the predetermined characteristic. The resulting residual stream is encoded and outputted as an enhancement stream.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 is a block diagram representing a known layered video encoder;

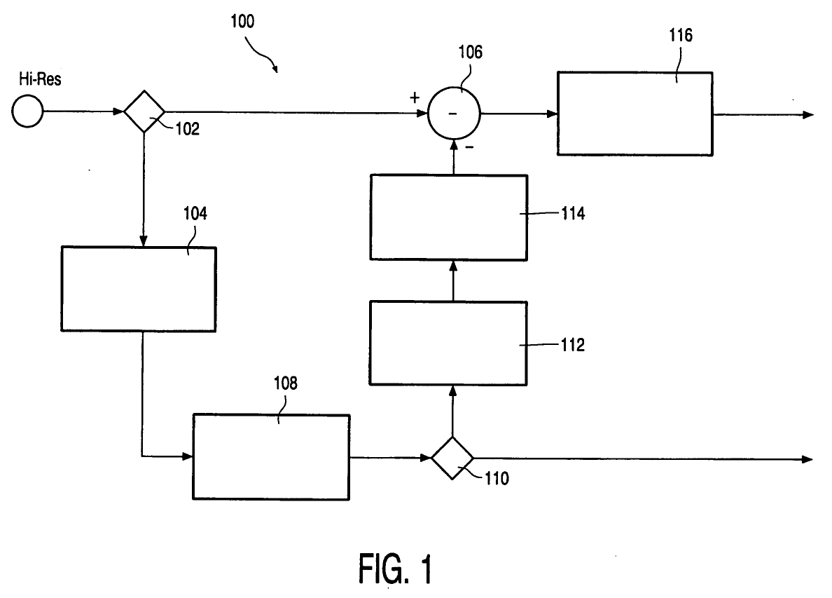

FIG. 2 is a block diagram of a layered video encoder according to one embodiment of the invention;

FIG. 3 is a block diagram of a layered video decoder according to one embodiment of the invention; and

FIG. 4 is a block diagram of a layered video encoder according to one embodiment of the invention.

### DETAILED DESCRIPTION OF THE INVENTION

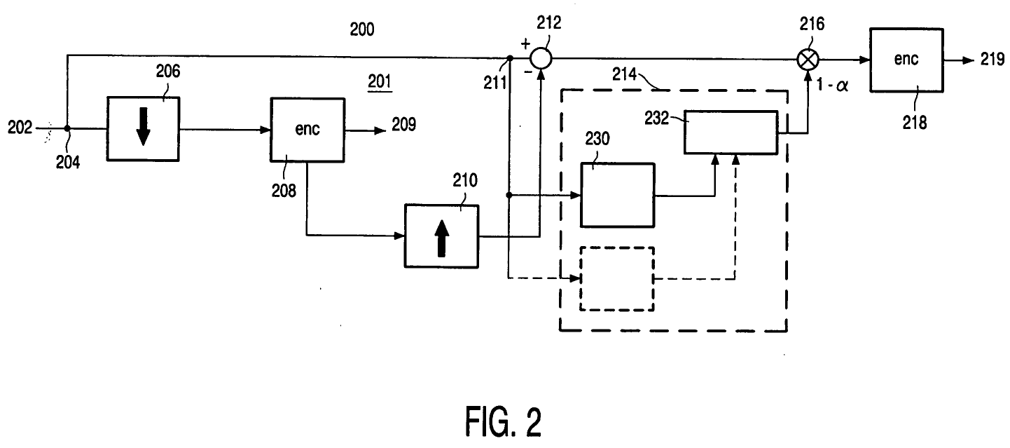

FIG. 2 is a block diagram of a layered video encoder/decoder 200 according to one embodiment of the invention. The encoder/decoder 200 comprises an encoding section 201 and a decoding section. A high-resolution video stream 202 is inputted into the encoding section 201. The video stream 202 is then split by a splitter 204, whereby the video stream is sent to a low pass filter 206 and a second splitter 211. The low pass filter or downsampling unit 206 reduces the resolution of the video stream, which is then fed to a base encoder 208. The base encoder 208 encodes the downsampled video stream in a known manner and outputs a base stream 209. In this embodiment, the base encoder 208 outputs a local decoder output to an upconverting unit 210. The upconverting unit 210 reconstructs the filtered out resolution from the local decoded video stream and provides a reconstructed video stream having basically the same resolution format as the high-resolution input video stream in a known manner. Alternatively, the base encoder 208 may output an encoded output to the upconverting unit 210, wherein either a separate decoder (not illustrated) or a decoder provided in the upconverting unit 210 will have to first decode the encoded signal before it is upconverted.

The splitter 211 splits the high-resolution input video stream, whereby the input video stream 202 is sent to a subtraction unit 212 and a picture analyzer 214. In addition, the reconstructed video stream is also inputted into the picture analyzer 214 and the subtraction unit 212. According to one embodiment of the invention, the picture analyzer 214 comprises al least one color tone detector/metric 230 and an alpha modifier control unit 232. In this illustrative example, the color tone detector/metric 230 is a skin-color tone detector. The detector 230 analyzes the original image stream and determines which pixel or group of pixels are part of a human face and or body based on their color tone and/or determines which pixel or group of pixels have at least a predetermined chance of being part of the human face or body based on their color tone. The predetermined chance indicates the degree of probability of the pixel or group of pixels of having the predetermined characteristic. The detector 230 sends this pixel information to the control unit 232. The control unit 232 then controls the alpha value for the pixels so that the alpha value is biased toward zero for pixels which have a skin tone and is biased toward 1 for pixels which do not have a skin tone. As a result, the residual stream will contain the faces and other body parts in the image, thereby enhancing the faces and other body parts in the decoded video stream.

It will be understood that any number of different tone detectors can be used in the picture analyzer 214. For example, a natural vegetation detector could be used to detect the natural vegetation in the image for enhancement. Furthermore, it will be understood that the control unit 232 can be programmed in a variety of ways on how to treat the information from each detector. For example, the pixels detected by the skin-tone detector and the pixels detected by the natural vegetation detector can be treated the same, or can be weighted in a predetermined manner.

As mentioned above, the reconstructed video stream and the high-resolution input video stream are inputted into the subtraction unit 212. The subtraction unit 212 subtracts the reconstructed video stream from the input video stream to produce a residual stream. The gain values from the picture analyzer 214 are sent to a multiplier 216 which is used to control the attenuation of the residual stream. The attenuated residual signal is then encoded by the enhancement encoder 218 to produce the enhancement stream 219.

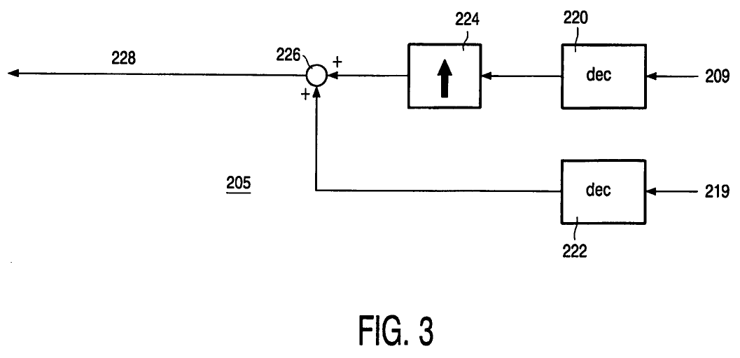

In the decoder section 205 illustrated in FIG. 3, the base stream 209 is decoded in a known manner by a decoder 220 and the enhancement stream 219 is decoded in a known manner by a decoder 222. The decoded base stream is then upconverted in an upconverting unit 224. The upconverted base stream and the decoded enhancement stream are then combined in an arithmetic unit 226 to produce an output video stream 228.

According to another embodiment of the invention, the areas of higher resolution are determined using depth and segmentation information. A larger object in the foreground of an image is more likely to be tracked by the human eye of the viewer than smaller objects in the distance or background scenery. Thus, the alpha value of pixels or groups of pixels of an object in the foreground can be biased toward zero so that the pixels are part of the residual stream.

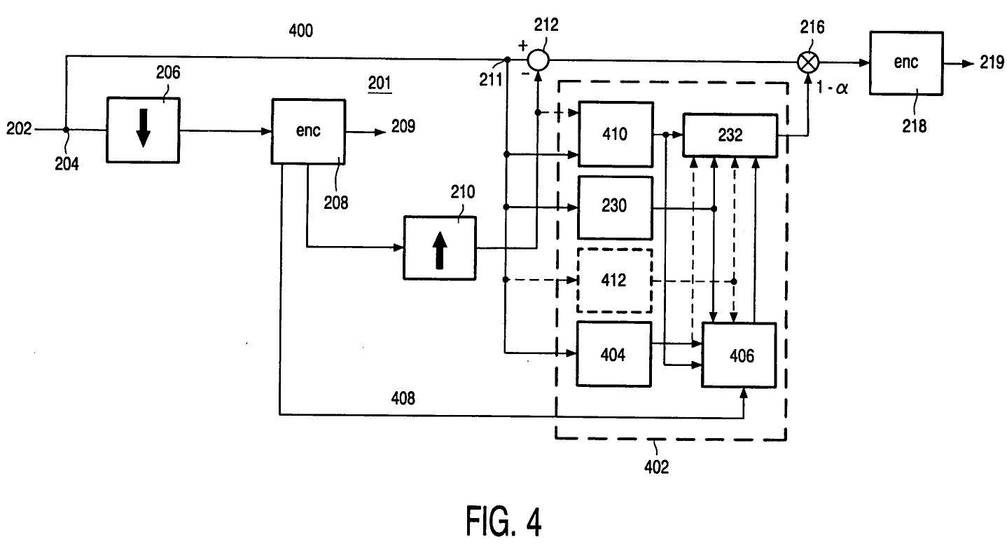

FIG. 4 illustrates an encoder 400 according to one embodiment of the invention. The encoder 400 is similar to the encoder 200 illustrated in FIG. 2. Like reference numerals have been used for like elements and a full description of the like elements will not be repeated for the sake of brevity. The picture analyzer 402 comprises, among other elements, a depth calculator 404, a segmentation unit 406, and an alpha modifier control unit 232. The original input signal is supplied to the depth calculator 404. The depth calculator 404 calculates the depth of each pixel or group of pixels in a known manner, e.g. the depth is the distance between the pixel belonging to the object and the camera, and sends the information to the segmentation unit 406. The segmentation unit 406 then determines different segments of the image based on the depth information. In addition, motion information in the form of motion vectors 408 from either the base encoder or the enhancement encoder can be provided to the segmentation unit 406 to help facilitate the segmentation analysis. The results of the segmentation analysis are supplied to the alpha modifier control unit 232. The alpha modifier control unit 232 the controls the alpha values for pixels or groups of pixels so that the alpha value is biased toward zero for pixels or larger objects in the foreground of the image. As a result, the resulting residual stream will contain larger objects in the foreground.

It will be understood that other components can be added to the picture analyzer 402. For example, as illustrated in FIG. 4, the picture analyzer 402 can contain a detail metric 410, a skin-tone detector/metric 230, and a natural vegetation detector/metric 412, but the picture analyzer is not limited thereto. As mentioned above, the control unit 232 can be programmed in a variety of way on how to treat the information received from each detector when determining how to bias the alpha value for each pixel or group of pixels. For example, the information from each detector can be combined in various ways. For example, the information from the skin tone detector/metric 230 can be used by the segmentation unit 406 to identify faces and other body parts which are in the foreground of the image.

The above-described embodiments of the invention enhance the efficiency of known spatial scalable compression schemes by lowering the bitrate of the enhancement layer by using adaptive content filtering to remove unnecessary bits from the residual stream prior to encoding.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. An apparatus for performing spatial scalable compression of video information captured in a plurality of frames, comprising:
a base layer encoder for encoding a bitstream;
an enhancement layer encoder for encoding a residual signal having a higher resolution than the base layer; and
a multiplier unit for attenuating the residual signal, the residual signal being the difference between the original frames and the upscaled frames from the base layer;
a picture analyzer for performing segmentation and determining which group of pixels in each frame have at least a predetermined chance of having a predetermined characteristic and calculating a gain value for the content of each pixel, wherein the gain for pixels which have the at least predetermined chance of having the predetermined characteristic is biased toward 1 and the gain for other pixels is biased toward 0, wherein the multiplier uses the gain value to attenuate the residual signal.

2. The apparatus according to claim 1, wherein segmentation size is one pixel.

3. The apparatus according to claim 1, wherein the picture analyzer comprises a color-tone detector for detecting pixels which have a predetermined color tone.

4. The apparatus according to claim 3, wherein the color-tone detector is a skin-tone detector.

5. The apparatus according to claim 3, wherein the color-tone detector is a natural vegetation color detector.

6. The apparatus according to claim 1, wherein the picture analyzer comprises:
a depth calculation unit for determining the depth of each pixel in the frame;
a segmentation unit for determining which pixels comprise various segments of images in each frame, wherein the gain for pixels which are part of objects in the foreground of the image in each frame is biased toward 1.

7. The apparatus according to claim 6, wherein the picture analyzer further comprises at least one color-tone detector, wherein the gain for pixels which have a predetermined color-tone or are part of objects in the foreground of the image in the frame is biased toward 1.

8. A layered encoder for encoding and decoding a video stream, comprising:
a downsampling unit for reducing the resolution of the video stream;
a base encoder for encoding a lower resolution base stream;
an upconverting unit for decoding and increasing the resolution of the base stream to produce a reconstructed video stream;
a subtractor unit for subtracting the reconstructed video stream from the original video stream to produce a residual signal;
a picture analyzer for performing segmentation and determining which groups of pixels in each frame have at least a predetermined chance of having a predetermined characteristic and calculating a gain value for the content of each pixel, wherein the gain for pixels which have the at least predetermined chance of having the predetermined characteristic is biased toward 1 and the gain for other pixels is biased toward 0;
a first multiplier unit which multiplies the residual signal by the gain values so as to remove bits from the residual signal which do not have the predetermined chance of having the predetermined characteristic;
an enhancement encoder for encoding the resulting residual signal from the multiplier and outputting an enhancement stream.

9. The layered encoder according to claim 8, wherein segmentation size is one pixel.

10. The layered encoder according to claim 8, wherein the picture analyzer comprises a color-tone detector for detecting pixels which have a predetermined color tone.

11. The layered encoder according to claim 10, wherein the color-tone detector is a skin-tone detector.

12. The layered encoder according to claim 10, wherein the color-tone detector is a natural vegetation color detector.

13. The layered encoder according to claim 8, wherein the picture analyzer comprises:
a depth calculation unit for determining the depth of each pixel in the frame;
a segmentation unit for determining which pixels comprise various segments of images in each frame, wherein the gain for pixels which are part of objects in the foreground of the image in each frame is biased toward 1.

14. The layered encoder according to claim 13, wherein the picture analyzer further comprises at least one color-tone detector, wherein the gain for pixels which have a predetermined color-tone or are part of objects in the foreground of the image in the frame is biased toward 1.

15. A method for providing spatial scalable compression using adaptive content filtering of a video stream, comprising the steps of:
downsampling the video stream to reduce the resolution of the video stream;
encoding the downsampled video stream to produce a base stream;
decoding and upconverting the base stream to produce a reconstructed video stream;
subtracting the reconstructed video stream from the video stream to produce a residual stream;
determining which segments or pixels in each frame have at least a predetermined chance of having a predetermined characteristic;
calculating a gain value for the content of each segment or pixel, wherein the gain for pixels which have the at least predetermined chance of having the predetermined characteristic is biased toward 1 and the gain for other pixels is biased toward 0;
multiplying the residual stream by the gain values so as to remove bits from the residual stream which do not have the predetermined chance of having the predetermined characteristic; and
encoding the resulting residual stream and outputting an enhancement stream.
